(19) United States
(12) Patent Application Publication
(10) Pub. No.: US 2008/0142044 A1
(43) Pub. Date: Jun. 19, 2008

(54) CLEANING APPARATUS AND METHOD OF CLEANING WORKPIECES

(75) Inventor: Hermann-Josef DAVID, Monschau (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Durr Ecoclean GmbH, Filderstadt (DE)

(21) Appl. No.: 11/950,195

(22) Filed: Dec. 4, 2007

Related U.S. Application Data
(63) Continuation of application No. PCT/EP2006/005459, filed on Jun. 8, 2006.

(30) Foreign Application Priority Data
Jun. 16, 2005 (DE) 10 2005 027 721.7

(51) Int. Cl. B08B 13/00

(52) U.S. Cl. 134/18; 134/113; 134/57 R; 134/104.1

(57) ABSTRACT

In order to provide a cleaning apparatus for cleaning workpieces, comprising at least one workpiece holder for a workpiece that is to be cleaned, that allows easy, flexible and reliable checking of the workpiece position, it is proposed that the cleaning apparatus comprises at least one ranging sensor that produces a signal, from which it is derivable whether a workpiece is held in the correct position on the workpiece holder.

### RELATED APPLICATION

This application is a continuation application of PCT/EP2006/005459 filed Jun. 8, 2006, the entire specification of which is incorporated herein by reference.

### FIELD FOR DISCLOSURE

The present invention relates to a cleaning apparatus for cleaning workpieces, which comprises at least one workpiece holder for a workpiece that is to be cleaned.

### BACKGROUND

Such cleaning installations are known from the prior art.

In particular, cleaning installations are known, in which checking of the correct position of the workpieces on the workpiece holder is effected by means of a silhouette sheet at the inlet of the cleaning apparatus. In this case, a conveying device guides the workpieces in a conveying direction through the silhouette sheet. The silhouette sheet has a cutout aperture that corresponds to the contour of the workpieces. If a workpiece is incorrectly positioned, the silhouette sheet is deflected and actuates a touch-sensitive sensor.

Such silhouette sheets have to be exchanged upon a change of the type of workpieces to be cleaned. Problems further arise when workpieces of differing external contour are conveyed alternately through the cleaning apparatus as each silhouette sheet is capable of detecting only the correct position of a specific type of workpiece having a specific external contour. The silhouette sheet moreover only allows checking of the workpiece position at the inlet of the cleaning apparatus. The provision of additional silhouette sheets inside the cleaning apparatus would impede access to the treatment stations and treatment devices of the cleaning apparatus.

Cleaning apparatuses are further known, in which the correct position of a workpiece to be cleaned on a workpiece holder is detected by means of a blow nozzle, from which compressed air is discharged such that it flows against the workpiece if the workpiece is correctly positioned on the workpiece holder. If the workpiece has been incorrectly positioned, the workpiece has moved at least partially out of the flow path of the discharged blown air, with the result that the back pressure of the blown air is lowered. By monitoring the back pressure it is therefore possible to detect an incorrect position of the workpiece. Such a method of detecting an incorrect position of a workpiece on a workpiece holder may however be used only if the workpiece is a short distance (for example no more than 3 mm) away from the blow nozzle. The method is therefore not usable if workpiece holder and blow nozzle are displaced relative to one another during operation of the cleaning apparatus. Furthermore, correct alignment of the blow nozzle is difficult and time-consuming.

### SUMMARY OF THE INVENTION

The underlying object of the present invention is therefore to provide a cleaning apparatus of the initially described type, which allows easy, flexible and reliable checking of the workpiece position.

In a cleaning apparatus having the features of the preamble of claim 1, this object is achieved according to the invention in that the cleaning apparatus comprises at least one ranging sensor, which produces a signal, from which it is derivable whether a workpiece is held in the correct position on the workpiece holder.

The ranging sensor produces a signal that varies in dependence upon the distance between the workpiece and the ranging sensor, so that from this signal it may be determined whether this distance lies within a preset setpoint range.

Preferably, the signal of the ranging sensor varies monotonically with increasing distance between workpiece and ranging sensor.

The signal produced by the ranging sensor is preferably an electrical signal that is characterized for example by voltage, current intensity, phase and/or frequency.

The ranging sensor may in this case be configured for example as a capacitive or an inductive sensor.

A capacitive sensor detects the dielectric variation caused by the presence of the workpiece.

An inductive sensor detects the variation of the magnetic permeability caused by the presence of the workpiece.

Particularly for checking the workpiece position of metal workpieces in an environment laden with impurities and cleaning medium it has proved advantageous if the ranging sensor is designed as an inductive sensor.

In this case, it is preferably provided that the ranging sensor does not touch the workpiece, the position of which is being checked, rather the ranging sensor effects contactless measurement of the distance between the workpiece and the sensor face.

Particularly reliable workpiece position checking is achieved if there are associated with the at least one workpiece holder at least two ranging sensors, which produce signals, from which it is derivable whether a workpiece is held in the correct position on the workpiece holder. In this way, deviations from the setpoint position of the workpiece that leave the distance of the workpiece from one of the ranging sensors unaltered are also detected because, in this case, the variation of the distance from a second ranging sensor is detected.

Preferably, the at least two ranging sensors are in this case disposed at mutually opposite sides of the same workpiece holder.

It has proved particularly advantageous if at least two ranging sensors are disposed diametrically, in particular diagonally opposite one another on the same workpiece holder.

In principle, it may be provided that the ranging sensors produce a digital or analogue output signal.

It has however proved particularly advantageous if at least one of the ranging sensors produces an analogue output signal.

In a preferred development of the invention, the cleaning apparatus comprises at least one evaluation device for evaluating the signal produced by the at least one ranging sensor.

In principle, the electronic evaluation of the signal produced by the at least one ranging sensor may be effected by means of a processor with suitable software (for example PLC) or however by means of a hardware circuit.

In a preferred development of the cleaning apparatus according to the invention, it is provided that the evaluation device is configured as a hardware circuit. Such a hardware circuit is particularly economical to manufacture and may be configured to be particularly insensitive to environmental influences.

In a preferred development of the cleaning apparatus according to the invention, it is provided that the evaluation device determines an incorrect position of a workpiece if the signal of at least one ranging sensor indicates too great a distance, i.e. a distance exceeding a maximum permissible limit distance, between the workpiece and the relevant ranging sensor.

The limit values of the output signal that are associated with each of the ranging sensors may be specified for the evaluation device by hardware, communicated through a data line and stored in the evaluation device or may however be learned by the evaluation device by means of a “teach-in” process.

It is preferably provided that at least one value of the signal of at least one ranging sensor that corresponds to a maximum permissible limit distance between the workpiece and the relevant ranging sensor can be stored in the evaluation device.

The cleaning apparatus further preferably comprises a control device, which at least partially disconnects the cleaning apparatus if the result of the evaluation of the signal of the at least one ranging sensor is that the workpiece is not held in the correct position on the workpiece holder. In this way, damage to the cleaning apparatus and the relevant workpiece as a result of a collision of the incorrectly positioned workpiece with treatment devices or other components of the cleaning apparatus may be prevented.

In a preferred development of the cleaning apparatus according to the invention, it is provided that at least one of the ranging sensors has at least the degree of protection IP 67, preferably the degree of protection IP 68.

These degrees of protection are defined in the standard DIN VDE 0470 Part 1, EN 60529 and IEC 529.

A ranging sensor having the degree of protection IP 67 is dustproof and protected against access to hazardous parts with a wire. A 1.0 mm diameter access probe should not penetrate. Furthermore, no dust should penetrate. A ranging sensor having the degree of protection IP 67 is moreover protected against the effects of temporary submersion in water. It therefore has to be of such a nature that water does not enter in a quantity that causes detrimental effects when the housing is temporarily submerged in water under the standard pressure- and time conditions in accordance with the previously mentioned standard.

A ranging sensor having the degree of protection IP 68 is moreover protected against the effects of permanent submersion in water. For this, it is required that water does not enter in a quantity that causes detrimental effects when the housing is permanently submerged in water, under conditions that are more difficult than the conditions defined in the previously mentioned standard for the degree of protection IP 67.

The effect achieved by designing the ranging sensor in accordance with the degree of protection IP 67, preferably the degree of protection IP 68, is that the ranging sensor remains functional even in the event of continuous operation in regions of the cleaning apparatus that are acted upon by a liquid cleaning medium.

At least one of the ranging sensors further advantageously comprises an enclosure, preferably an enclosure made of a plastics material.

In particular, it may be provided that the electronic sensing equipment is cast in a plastic enclosure (for example of Hostaform®) with synthetic resin.

By means of such an enclosure the operating distance between the electronic sensing equipment, on the one hand, and any impurities, for example swarf, present on a surface of the ranging sensor is increased, thereby preventing the ranging sensor from already responding to the presence of such impurities.

The enclosure moreover protects the electronic sensing equipment from mechanical damage and fouling as well as against moisture and deposits of the cleaning medium used in the cleaning apparatus.

In order to remove accumulations of impurities, for example swarf, which might lead to malfunctions of the ranging sensor, from a surface of the ranging sensor, the cleaning apparatus may comprise at least one spraying device for spraying at least one ranging sensor with a cleaning liquid, in particular with water.

In order to ensure that only a correctly positioned workpiece may reach the preset setpoint distance from the at least one ranging sensor, it is advantageous if at least one of the workpiece holders has at least one connecting link that prevents a workpiece, which is not held in the correct position on the workpiece holder, from being able to adopt the same distance from the at least one ranging sensor as a workpiece that is held in the correct position on the workpiece holder.

Such mechanical connecting links may comprise for example pillars, supporting bases and location pins.

Incorrectly positioned workpieces are kept at a distance from the at least one ranging sensor by means of such connecting links.

The at least one workpiece holder, on which the workpiece position check occurs, may be a workpiece holder disposed in a stationary manner in the cleaning apparatus or a movable workpiece holder.

It may therefore be provided that at least one workpiece holder, on which the correct position of the workpiece is determined, is disposed in a substantially stationary manner in a treatment station of the cleaning apparatus.

Alternatively or in addition thereto, it may be provided that the cleaning apparatus comprises at least one conveying device, by means of which the workpieces are conveyed through the cleaning apparatus, and that at least one workpiece holder, on which the correct position of the workpiece is determined, is disposed on the conveying device.

Such a conveying device may be designed in particular as a walking beam.

A further underlying object of the present invention is to provide a method of cleaning workpieces in a cleaning apparatus comprising at least one workpiece holder for a workpiece that is to be cleaned, which method comprises an easy, flexible and reliable workpiece position check.

According to the invention, this object is achieved in that by means of at least one ranging sensor a signal is produced, from which it is derived whether a workpiece is held in the correct position on the workpiece holder.

Special developments of the method according to the invention are the subject matter of claims 21 and 22, the advantages of which have already been explained in connection with the special developments of the cleaning apparatus according to the invention.

Further features and advantages of the invention are the subject matter of the following description and graphic representation of an embodiment.

### BRIEF DESCRIPTION OF THE DRAWINGS

FIG. 1 a diagrammatic side view of a walking beam conveyor with a movable workpiece holder and of a treatment station with a stationary workpiece holder, viewed in a horizontal direction at right angles to the conveying direction;

FIG. 2 a diagrammatic front view of the walking beam and the treatment station of FIG. 1, viewed parallel to the conveying direction;

FIG. 3 a diagrammatic plan view of the movable workpiece holder of the walking beam and of the stationary workpiece holder of the treatment station;

FIG. 4 a diagrammatic cross section through a workpiece holder and a ranging sensor disposed on the workpiece holder as well as a spray device for cleaning the ranging sensor;

FIG. 5 a diagrammatic side view of a workpiece holder with a workpiece held in the correct position on the workpiece holder;

FIG. 6 a diagrammatic side view of a workpiece holder with a workpiece held in an incorrect position on the workpiece holder; and

FIG. 7 a diagrammatic side view of a workpiece holder with a workpiece held in a correct limit position on the workpiece holder by a distance piece, during the implementation of a “teach-in” process for setting an evaluation device to a still tolerable limit value of the output signal of the ranging sensor.

Identical or functionally equivalent elements are denoted by the same reference characters in all of the figures.

### DETAILED DESCRIPTION OF THE INVENTION

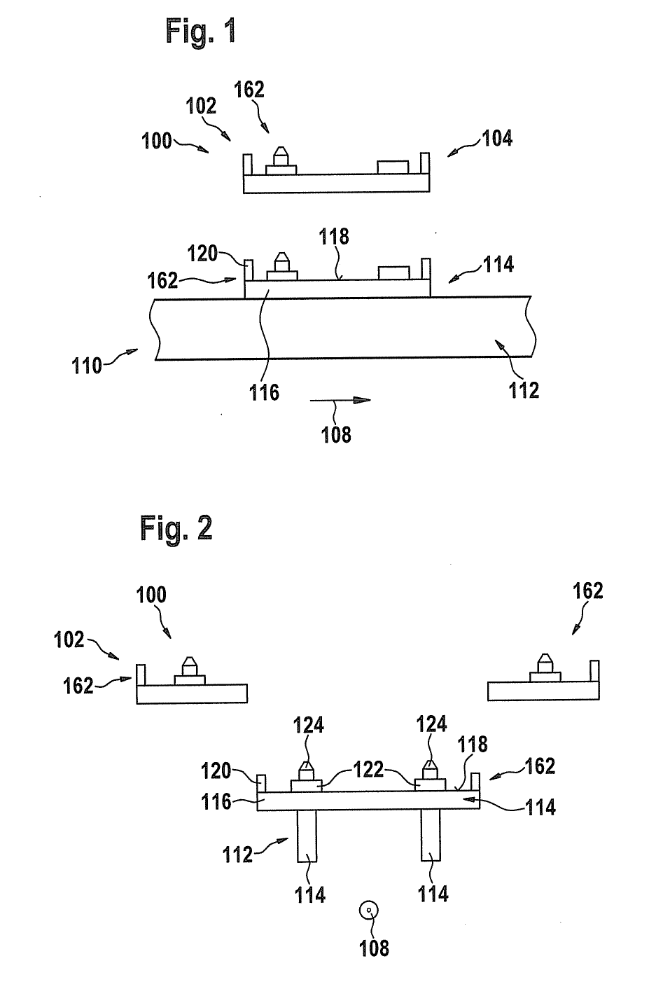

A cleaning apparatus represented in FIGS. 1 to 7 and denoted as a whole by 100 comprises a plurality of treatment stations 102, in each of which one treatment step for cleaning a workpiece is carried out and of which one is represented in FIGS. 1 to 3.

Each of the treatment stations 102 comprises a stationary workpiece holder 104, of the type represented in FIGS. 1 to 3, as well as treatment tools (not shown) for carrying out cleaning of a workpiece, for example blow nozzles, spray nozzles, movable spray lances or the like.

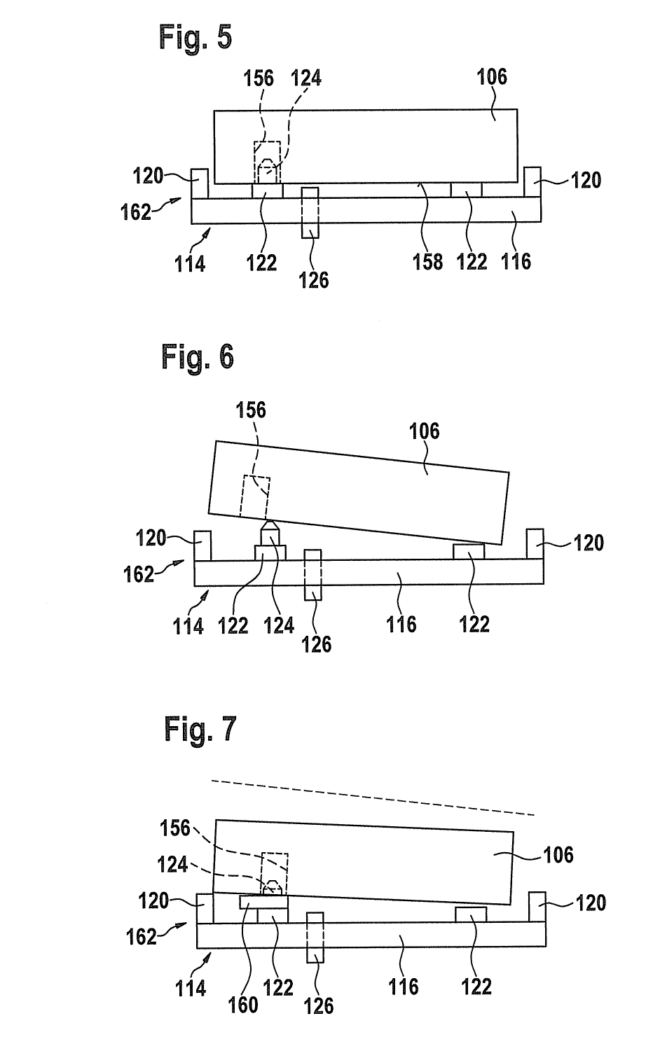

In order to be able to move workpieces 106 to be cleaned (see FIGS. 5 to 7) in a conveying direction 108 (see FIGS. 1 to 3) from the stationary workpiece holder 104 of a first treatment station 102 to the stationary workpiece holder 104 of a second treatment station 102 lying in conveying direction 108 downstream of the first treatment station, the cleaning apparatus 100 comprises a conveying device 110 in the form of a walking beam 112, which comprises two rails 114 extending in the conveying direction 108 and carrying an equivalent number of movable workpiece holders 114 to the number of stationary workpiece holders 104 of the processing station 102, one of these movable workpiece holders 114 being represented in FIGS. 1 to 3.

Each of the movable workpiece holders 114 comprises a substantially cuboidal base plate 116, which at the four corners of its upper side 118 is provided with pillars 120 that project up from the upper side 118.

Slightly inwards of the pillars 120 the base plate 116 is further provided with four substantially cylindrical supporting bases 122 that project up from the upper side 118 of the base plate 116.

At least one of the supporting bases 122, preferably a plurality of supporting bases 122 are provided in each case with a location pin 124 that projects up from the upper side of the respective supporting base 122.

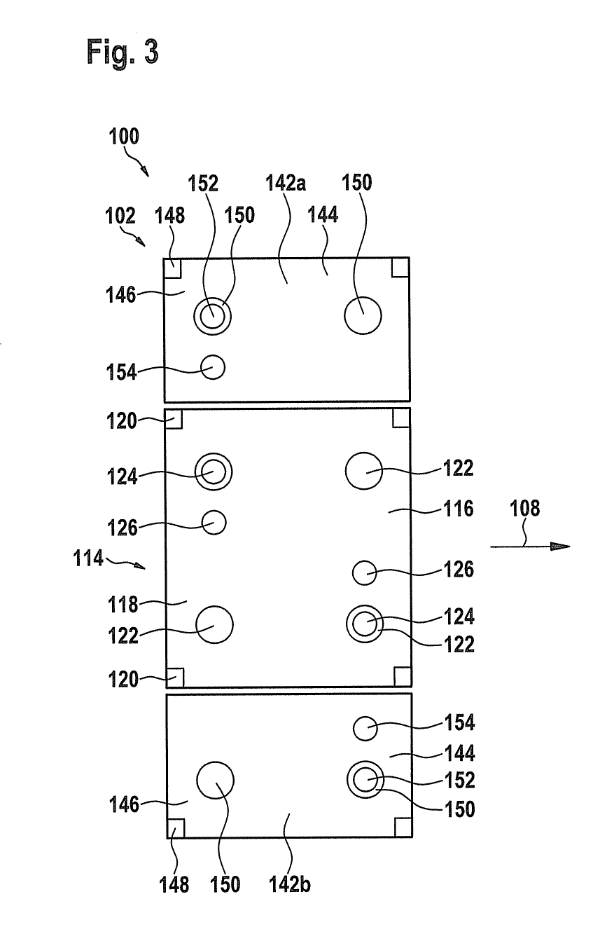

As may best be seen from FIGS. 3 and 5, on the movable workpiece holder 114 two ranging sensors 126 are disposed in each case adjacent to a supporting base 122 with location pin 124.

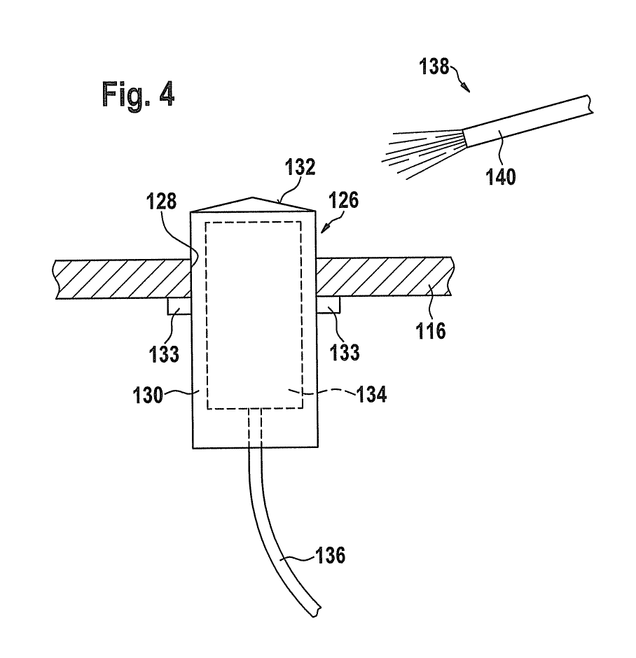

As may best be seen from the enlarged representation of FIG. 4, each of the ranging sensors 126 passes through a hole 128 in the base plate 116 of the workpiece holder.

The ranging sensor 126 comprises a substantially cylindrical enclosure 130 made of a plastics material, for example a synthetic resin, which at its top end facing the workpiece 106 is provided with a bevelled surface 132, which may in particular have a substantially conical shape.

On its peripheral surface the enclosure 130 is provided with radially projecting stops 133 or with a radially projecting stop collar, by means of which the ranging sensor 126 is fastened at a preset level relative to the base plate 116 of the workpiece holder 114.

The electronic sensing equipment 134 of the ranging sensor 126 is cast into the enclosure and hence protected from fouling and other environmental influences.

From the electronic sensing equipment 134 a signal cable 136 runs out through the enclosure 130 to an evaluation device (not shown), which receives an analogue output signal from the electronic sensing equipment 134 of the ranging sensor 126.

In the region of the inoperative position represented in FIGS. 1 to 3 of the movable workpiece holder 114 a spray device 138 with a spray nozzle 140 is further disposed in such a way that the spray nozzle 140 is oriented towards the bevelled surface 132 of the ranging sensor 126, so that by means of the spray nozzle 140 the upper part of the ranging sensor 126 including the bevelled surface 132 may be cleaned by spraying or splashing it with a liquid cleaning medium, for example with water.

The spraying device 138 may in particular remove oil and/or accumulations of swarf or other impurities, which originate from the workpieces 106 to be cleaned or from the cleaning medium used in the cleaning apparatus 100, from the ranging sensor 126 in order to prevent metal impurities in particular from impairing the function of the ranging sensor 126.

The stationary workpiece holders 104 of the processing station 102 are of a similar construction to the movable workpiece holders 114 disposed on the walking beam 112 but are of a two-part construction instead of a one-part construction.

Each of the stationary workpiece holders 104 comprises two partial workpiece holders 142a and 142b, which are spaced apart from one another in a horizontal direction at right angles to the conveying direction 108, wherein the spacing between the two partial workpiece holders 142a, 142b exceeds the extent of the movable workpiece holder 114 in the horizontal direction at right angles to the conveying direction 108, with the result that the movable workpiece holder 114 may be moved through between the two stationary partial workpiece holders 142a, 142b in order to lift a workpiece off the stationary workpiece holder 104 by means of the movable workpiece holder 114.

Each of the stationary partial workpiece holders 142a, 142b comprises a substantially cuboidal base plate 144, which at two of its corners is provided with pillars 148 that project up from the upper side 146.

Inwards of the pillars 148 supporting bases 150 are provided, which project up from the upper side 146 of the base plate 144 and of which in each case one is provided at its upper side with a location pin 152.

On the base plate 144 of each of the partial workpiece holders 142a and 142b a ranging sensor 154 is disposed adjacent to the supporting base 150 with location pin 152.

In this case, the ranging sensors 154 of the stationary workpiece holder 104 are configured and disposed on the respective base plate 144 in the same manner as the ranging sensors 126 of the movable workpiece holder 114 are on the base plate 116 of the movable workpiece holder 114.

One or more spraying devices 138 may moreover also be associated with each ranging sensor 154 of the stationary workpiece holder 104 for cleaning the part of the respective ranging sensor 154 that projects beyond the base plate 144.

The ranging sensors 154 are also connected by signal cables to an evaluation device of the cleaning apparatus 100.

In FIG. 5 it is diagrammatically represented how a workpiece 106 having a bore 156 is held in the correct position on a movable workpiece holder 114, wherein the workpiece 106 rests with its underside 158 on the upper sides of the supporting bases 122 of the workpiece holder 114 and the location pins 124 of the workpiece holder 114 engage into the respective associated bores 156 of the workpiece 106.

In the present case, the ranging sensors 126, which are designed as inductive sensors, produce an analogue output signal that is dependent upon the distance between the workpiece 106 formed from an electrically conductive material, on the one hand, and the electronic sensing equipment 134 of the ranging sensor 126, on the other hand.

This output signal is preferably an electrical signal that is characterized by its voltage, current strength, phase and/or frequency.

The analogue output signals of the ranging sensors 126 (with current strengths of for example 4 mA to 20 mA) are electronically evaluated in the evaluation device, which may in particular be configured as a hardware circuit, and compared with limit values, which are associated with the respective ranging sensors 126 and correspond to an only just tolerable distance between the workpiece 106 and the respective ranging sensors 126.

If the workpiece 106 is positioned correctly on the workpiece holder 104, the analogue output signal produced at the ranging sensors 126 lies above the respective limit value, this indicating that the distance between the workpiece 106 and the ranging sensors 126 lies below the still tolerable limit distance. The evaluation device therefore supplies an evaluation signal, which indicates that the workpiece 106 is held in the correct position on the workpiece holder 114, and initiates no further control measures.

Depending on the type of ranging sensor 126 used, the analogue output signal may with increasing distance of the workpiece 106 from the ranging sensor 126 also increase, so that in this case an undershooting of the respective limit value indicates a correct position of the workpiece 106 on the workpiece holder 114.

If, on the other hand, the workpiece 106 on the workpiece holder 114 is situated in the incorrect position represented in FIG. 6, in which the workpiece 106 is tilted relative to the correct position, for example because one of the location pins 124 of the workpiece holder 114 is unable to engage into the associated bore 156 at the underside 158 of the workpiece 106 because of the exceeding of dimensional tolerances at the workpiece holder 114 and/or at the workpiece 106 or because of damage to the workpiece holder 114 and/or the workpiece 106, then in this incorrect position of the workpiece 106 on the workpiece holder 114 the distance between the workpiece 106 and the ranging sensors 126 exceeds the only just tolerable limit distance in relation to at least one of the ranging sensors 126, for which reason the relevant ranging sensor 126 supplies an analogue output signal that lies below the limit value associated with the relevant ranging sensor 126.

In this case, the result of the evaluation in the evaluation device is that the permissible limit value of the analogue output signal with regard to at least one of the ranging sensors 126 of the workpiece holder 114 has been undershot, for which reason the evaluation device produces an evaluation signal that indicates that the workpiece 106 is situated in an incorrect position on the workpiece holder 114.

This evaluation signal is communicated to a control device (not shown) of the cleaning apparatus 100 and has the effect that the control device disconnects the cleaning apparatus 100 at least partially, namely at least in the region where the relevant workpiece holder 114 with the incorrectly positioned workpiece 106 is situated, in order to prevent treatment devices of a processing station 102 or other components of the cleaning apparatus 100 from colliding with the incorrectly positioned workpiece 106.

The limit values of the analogue output signal that are associated with each of the ranging sensors 126 may be specified for the evaluation device by hardware, communicated through a data line and stored in the evaluation device or may however be entered by means of a “teach-in” process, which is described below with reference to FIG. 7.

For this “teach-in” process a workpiece 106 is brought deliberately into an only just acceptable limit position on the workpiece holder 114 in that, before the workpiece 106 is mounted, a distance piece 160 is mounted on one of the supporting bases 122 of the workpiece holder 114 that is provided with a location pin 124.

After the subsequent mounting of the workpiece 106, because of the distance piece 160 disposed between the workpiece 106 and the workpiece holder 114 the workpiece 106 is tilted in such a way relative to its correct position on the workpiece holder 114 that the distance between the workpiece 106 and the ranging sensor 126 adjacent to the supporting base 122 carrying the distance piece 160 corresponds to an only just tolerable limit distance of for example 3 mm.

The value of the analogue output signal that is produced in this situation by the relevant ranging sensor 126 is stored in a memory of the evaluation device, for example after actuation of a “teach-in” switch, as the limit value of the analogue output signal that is associated with the relevant ranging sensor.

In this way, by placing the distance piece 160 in turn on all of the supporting bases 122 that lie adjacent to one of the ranging sensors 126 of the workpiece 114, the associated limit value of the analogue output signal for each ranging sensor 126 is stored in the evaluation device.

If during operation of the cleaning apparatus 100 one of these limit values is undershot because of an incorrect position of the workpiece 106 on the workpiece holder 114, then the evaluation device produces an evaluation signal that indicates the incorrect position of the workpiece 106 on the workpiece holder 114 and triggers an at least partial disconnection of the cleaning apparatus 100.

The supporting bases 122, the location pins 124 and the pillars 120 of the workpiece holder 114 in this case act as mechanical connecting links 162, which limit the ways that the workpiece 106 may be mounted on the workpiece holder 114 in such a way that only a workpiece 106 that is correctly positioned on the workpiece holder 114 may achieve a distance in relation to all of the ranging sensors 126 of the workpiece holder 114 that does not exceed the respective permissible limit distance. Incorrectly positioned workpieces 106, on the other hand, are held by these mechanical connecting links 162 at a distance from the ranging sensors 126 that exceeds the permissible limit distance in relation to at least one of the ranging sensors 126.

As they move through the cleaning apparatus 100, the workpieces 106 switch in each case from a movable workpiece holder 114 of the walking beam 112 to a stationary workpiece holder 104 of a treatment station 102 and, on completion of the treatment process in this treatment station 102, onto the next movable workpiece holder 114 following on in conveying direction 108.

This switch is effected in that the walking beam 112 with an empty movable workpiece holder 114 is moved vertically upwards until the movable workpiece holder 114 lifts the workpiece 106 off the stationary workpiece holder 104 of the treatment station 102, the walking beam 112 then being moved forward in the conveying direction 108 by the distance of two successive stationary workpiece holders 104 and lowered again in vertical direction, wherein the workpiece 106 is set down on the next stationary workpiece holder 104 that follows. The walking beam 112, having offloaded the workpiece 106, is then moved counter to the conveying direction 108 back into its starting position and a further conveying cycle of the walking beam 112 may then begin.

The ranging sensors 154 of the stationary workpiece holders 104 may likewise be designed as inductive sensors and operate in the same way as has been described above with regard to the ranging sensors 126 of the movable workpiece holders 114.

Entry and/or storage of the limit values of the analogue output signals that are associated with each of the ranging sensors 154 of the stationary workpiece holders 104 may also be effected in the same way as for the ranging sensors 126 of the movable workpiece holders 114.

Furthermore, in the case of the stationary workpiece holders 104 too, the supporting bases 150, the location pins 152 and the pillars 148 of the workpiece holders 104 may serve as mechanical connecting links 162, which ensure that an incorrectly positioned workpiece 106 exceeds the permissible limit distance from at least one of the ranging sensors 154 of the stationary workpiece holder 104.

1. Cleaning apparatus for cleaning workpieces, comprising at least one workpiece holder for a workpiece that is to be cleaned, wherein the cleaning apparatus comprises at least one ranging sensor that produces a signal, from which it is derivable whether a workpiece is held in the correct position on the workpiece holder.

2. Cleaning apparatus according to claim 1, wherein the ranging sensor is configured as an inductive sensor.

3. Cleaning apparatus according to claim 1, wherein the ranging sensor does not touch the workpiece.

4. Cleaning apparatus according to claim 1, wherein there are associated with the at least one workpiece holder at least two ranging sensors, which produce signals, from which it is derivable whether a workpiece is held in the correct position on the workpiece holder.

5. Cleaning apparatus according to claim 4, wherein at least two ranging sensors are disposed on mutually opposite sides of the same workpiece holder.

6. Cleaning apparatus according to claim 5, wherein at least two ranging sensors are disposed diametrically opposite one another on the same workpiece holder.

7. Cleaning apparatus according to claim 1, wherein at least one of the ranging sensors produces an analogue output signal.

8. Cleaning apparatus according to claim 1, wherein the cleaning apparatus comprises at least one evaluation device for evaluating the signal produced by the at least one ranging sensor.

9. Cleaning apparatus according to claim 8, wherein the evaluation device is configured as a hardware circuit.

10. Cleaning apparatus according to claim 8, wherein the evaluation device determines an incorrect position of a workpiece if the signal of at least one ranging sensor indicates too great a distance between the workpiece and the relevant ranging sensor.

11. Cleaning apparatus according to claim 8, wherein there can be stored in the evaluation device at least one value of the signal of at least one ranging sensor that corresponds to a maximum permissible limit distance between the workpiece and the relevant ranging sensor.

12. Cleaning apparatus according to claim 1, wherein the cleaning apparatus comprises a control device, which at least partially disconnects the cleaning apparatus if the result of evaluation of the signal of the at least one ranging sensor is that the workpiece is not held in the correct position on the workpiece holder.

13. Cleaning apparatus according to claim 1, wherein at least one of the ranging sensors has at least the degree of protection IP 67, preferably the degree of protection IP 68.

14. Cleaning apparatus according to claim 1, wherein at least one of the ranging sensors comprises an enclosure, preferably an enclosure made of a plastics material.

15. Cleaning apparatus according to claim 14, wherein the enclosure of the ranging sensor is provided with a bevelled surface.

16. Cleaning apparatus according to claim 1, wherein the cleaning apparatus comprises at least one spraying device for spraying at least one ranging sensor with a cleaning liquid, in particular with water.

17. Cleaning apparatus according to claim 1, wherein at least one of the workpiece holders has at least one connecting link, which prevents a workpiece, which is not held in the correct position on the workpiece holder, from adopting the same distance from the at least one ranging sensor as a workpiece that is held in the correct position on the workpiece holder.

18. Cleaning apparatus according to claim 1, wherein at least one workpiece holder, on which the correct position of the workpiece is determined, is disposed in a substantially stationary manner in a treatment station of the cleaning apparatus.

19. Cleaning apparatus according to claim 1, wherein the cleaning apparatus comprises at least one conveying device, by means of which the workpieces are conveyed through the cleaning apparatus, and wherein at least one workpiece holder, on which the correct position of the workpiece is determined, is disposed on the conveying device.

20. Method of cleaning workpieces in a cleaning apparatus that comprises at least one workpiece holder for a workpiece that is to be cleaned, wherein that by means of at least one ranging sensor a signal is produced, from which it is derived whether a workpiece is held in the correct position on the workpiece holder.

21. Method according to claim 20, wherein the signal produced by at least one ranging sensor is evaluated by means of an evaluation device.

22. Method according to claim 21, wherein there is stored in the evaluation device at least one value of the signal of the at least one ranging sensor that corresponds to a maximum permissible limit distance between the workpiece and the relevant ranging sensor.
